(19) United States
(12) Patent Application Publication
(10) Pub. No.: US 2003/0084200 A1
(43) Pub. Date: May 1, 2003

(54) System and method for generating programmable traps for a communications network

(75) Inventors: Mark S. Buehler, Cedar Park, TX (US); Victor M. Santiago, Round Rock, TX (US); Charles B. Schreiber, Austin, TX (US)

Correspondence Address: Michael R. Barre, Baker Botts L.L.P., Suite 600, 2001 Ross Avenue, Dallas, TX, 75201-2980, US

(73) Assignee: VTEL Corporation, Austin, TX (US)

(21) Appl. No.: 10/002,693

(22) Filed: Oct. 31, 2001

(51) Int. Cl. G06F 9/46

(52) U.S. Cl. 709/318; 709/323

(57) ABSTRACT

A method is provided that issues custom traps for a network containing disparate network devices. In the method, a custom trap is stored in a network manager. The custom trap includes a triggering condition for a selected device among the network devices. The network manager monitors the selected device to detect whether the triggering condition has been met. In response to detecting that the triggering condition has been met, the network manager automatically issues the custom trap. In an example embodiment, the network manager stores the custom trap in a Simple Network Management Protocol (SNMP) agent, and the SNMP agent automatically issues the custom trap to an administrative workstation. The custom traps may be used to send uniform traps for network devices to an administrative workstation, despite differences in trap configurations, if any, in the network devices.

### CROSS-REFERENCE TO RELATED APPLICATIONS

This application is related to provisional U.S. Patent Application Serial No. 60/309,136, attorney docket number 021556.0125, entitled “System and Method for Managing Disparate Video Network Devices Through a Management Information Base,” and naming as inventors Mark S. Buehler, Kurtis L. Seebalt, and Victor M. Santiago (hereinafter “the related application”). The related application is hereby incorporated herein by reference.

### TECHNICAL FIELD OF THE INVENTION

This invention relates in general to network communications. In particular, the invention relates to a system and method for providing programmable traps for networks such as video networks.

### BACKGROUND OF THE INVENTION

Video conference calls have grown in popularity as the expense of video conferencing devices has decreased and the availability of broadband communication networks has increased. Businesses often prefer the more personal communication available through video conferences, compared with telephone conferences, and also enjoy savings in travel costs while still having a personal presence among the participants that is not possible with audio only communications. The increased popularity of video conferencing has resulted in the deployment of video network devices in wide ranging disparate locations, with the devices interfaced by business networks and/or public networks.

Often, video calls involve the interfacing of video network devices manufactured by a variety of different manufacturers and using a variety of protocols and network communication interfaces. For instance, a single video network might include video endpoints, multi-point control units (MCUs), and gateways manufactured by different manufacturers, and each device may use a different communications protocol (e.g., Simple Network Management Protocol (SNMP), Hypertext Transfer Protocol (HTTP), Telnet, VT-100, etc.), a different physical interface (e.g., Ethernet, RS-232, Universal Serial Bus (USB), etc.), and a different program interface. In addition, video data traverses routers, switches, private branch exchanges (PBXs), and other non-video equipment. Each of these devices may include specific management, maintenance, and monitoring requirements, and this multitude of individual requirements makes it difficult to manage the video network effectively and efficiently.

Although the International Telecommunication Union (ITU) has accepted H.341 as a standard multimedia Management Information Base (MIB), few vendors implement this standard, and many devices lack the SNMP interface used by the standard. Furthermore, different vendors of video conferencing devices typically provide their own proprietary mechanisms for device management. Consequently, when a video network includes devices from several such vendors, it has been necessary to use multiple management platforms (e.g., video network management software and/or hardware) to manage the devices. Each management platform may provide a different set of management functions or options and a different management user interface. Therefore, in a conventional video network, the job of network management may be further complicated by the necessity of using two or more different management platforms and the necessity of reconciling the different sets of functionality provide by those different platforms, in light of the specific management objectives for that network.

For example, one crucial element of network management is maintaining a report of the status of the video devices. A network management station (NMS) may be used to store the status information. A status report from a device may include such information as whether the device is ready for use, whether it is in a loading condition and not yet ready for use, or whether it is in an error condition that warrants the raising of an alarm. Some video devices that use SNMP come from the manufacturer configured to automatically issue traps that provide status updates. The manufacturer determines what conditions should cause traps to be issued and preconfigures the devices accordingly. Thus, it is not unusual for different devices in a video network to issue traps based on different types of events. Furthermore, even for devices that generate traps based on the same type of event (e.g., numbers of line errors that indicate a noisy communication link), different vendors may trigger generation of those traps at different thresholds.

Consequently, the conditions that manufacturers choose as triggering events and the information reported by the issued traps frequently do not meet the needs of particular video networks. For example, since the traps are triggered according to thresholds defined by the device vendor, the traps frequently do not indicate conditions which a network administrator would consider worthy of “alarm” status (e.g., conditions which justify providing immediate administrator notification or requesting immediate administrator intervention). Consequently, rather than translating traps directly into user alarms, a network management station may simply record traps into logs for future reference, perhaps with user notification for the network administrator that a non-critical trap has been received.

For devices that support SNMP but do not issue traps, it is generally possible to retrieve status reports by polling the devices. A disadvantage of polling, however, is that it increases network traffic, particularly when devices are polled at short intervals in an attempt to approximate real-time status updates. The network administrator may manually configure the network management station to periodically poll some or all of the video devices, with the polling period selected to balance the increased overhead required for more frequent polling against the loss of real time status information. However, for a device that supports Internet Protocol (IP) but does not support SNMP, it may be possible to retrieve an IP address from the device, but other status information is typically unavailable. Furthermore, for devices that do not even support IP (e.g., devices that provide only RS-232 interfaces), even less status information may be available.

Thus, additional disadvantages associated with conventional video networks include an inability to obtain uniform kinds of status information from different devices and a lack of control with regard to when status updates will be provided and with regard to what status information will be received. Furthermore, these disadvantages are not limited to video networks but are also experienced to varying degrees in other types of computer networks.

The related application describes a video network with a user interface that provides for a consistent manner of access to disparate video network devices. The related application thus alleviates some of the difficulties associated with managing video networks with disparate video devices. However, as recognized by the present disclosure, there remains a need for more efficient and effective means for monitoring network device status and for providing user alarms in networks with disparate devices.

### SUMMARY OF THE INVENTION

The present invention involves a method, a system, and a program product that provide for custom traps for a network containing disparate network devices. According to the method, a custom trap is stored in a network manager. The custom trap includes a triggering condition for a selected device among the network devices. The network manager monitors the selected device to detect whether the triggering condition has been met. In response to detecting that the triggering condition has been met, the network manager automatically issues the custom trap.

In an example embodiment, the network manager stores the custom trap in a Simple Network Management Protocol (SNMP) agent, and the SNMP agent automatically issues the custom trap to an administrative workstation. The custom traps may be used to send uniform traps for network devices to an administrative workstation, despite differences in trap configurations, if any, in the network devices.

In the example embodiment, a user such as a network administrator selects the device attributes and associated thresholds to be included in the trap definitions. In addition, traps may be based on attributes of multiple devices and/or on generalized network conditions, such as time of day, day of week, overall traffic level, etc. Also, for each different trap, the network administrator may define different alert levels and response actions, such as logging the trap, paging a responsible person, and/or sending e-mail to a particular recipient. The network manager also accepts registration from multiple network management stations and provides for a different subset of traps to be associated with each network management station. Also, the example embodiment automatically adjusts polling between the network manager and the network devices, based on the trap list, to refresh data only as frequently as is necessary to satisfy the requirements of the custom traps.

An advantage of the example embodiment is that, in effect, it allows network administrators to supplement or replace vendor-defined traps in the network devices with user-defined traps in the network manager. Another advantage is that alerts can be generated under precisely the conditions of importance to the user, rather than according conditions specified by manufacturers of network devices. Furthermore, uniform alerts can be generated even though the network may contain devices from different vendors and with different communications protocols and program interfaces, including devices that might not otherwise provide status information. The example embodiment also minimizes the amount of polling between the network manager and the network devices. Additionally, since the network manager automatically issues the user-defined traps to network management stations, the network manager eliminates the need for network management stations to conduct polling.

Additional technical advantages provided by various embodiments of the invention will become apparent upon review of the following material, which includes a detailed description of an example embodiment of the invention.

### BRIEF DESCRIPTION OF THE DRAWINGS

Additional features, functions, and technical advantages will become apparent upon review of the following description, claims, and figures, in which:

FIG. 1 presents a block diagram of an example embodiment of a video network;

FIG. 2 presents a more detailed block diagram of certain components from the video network of FIG. 1;

FIG. 3 depicts an example discovered device list according to FIG. 2;

FIG. 4 present a block diagram of an example trap definition module according to FIG. 2;

FIG. 5 depicts an example NMS-traplist lookup table according to FIG. 2;

FIG. 6 depicts an example custom trap list according to FIG. 2;

FIG. 7 present a flowchart of an example process for providing custom traps for a video network; and

FIG. 8 presents a block diagram of the video network manager of FIG. 1.

### DETAILED DESCRIPTION

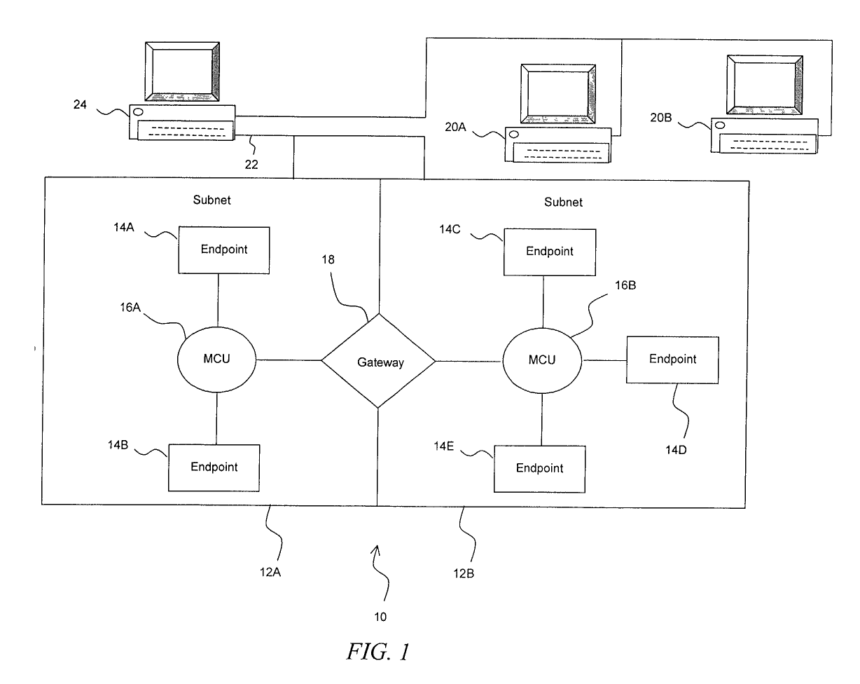

Referring now to FIG. 1, an example embodiment of a video network 10 includes a subnet 12A, a subnet 12B, and a video network manager 24 which communicates with subnets 12A and 12B via an administrative connection 22. Subnet 12A includes two endpoints 14A and 14B and a multi-point control unit (MCU) 16A. Endpoints 14A and 14B each include a camera for capturing video images, a microphone for capturing audio, and output devices such as video displays and speakers for presenting output such as video and audio captured from a remote source. MCU 16A receives input from endpoints 14A and 14B for transmission to a remote location. MCU 16A also receives audio and video data from a remote location and forwards that data to endpoints 14A and 14B. Similarly, subnet 12B includes an MCU 16B, as well as three endpoints 14C, 14D, and 14E, and subnet 12B operates in a manner generally similar to subnet 12A.

In the example embodiment, subnets 12A and 12B use different communications standards, and a gateway 18 serves as a bridge between subnets 12A and 12B, converting data between the different standards as necessary to support intercommunication. For instance, the equipment within subnet 12A may communicate using the ITU Telecommunications Standardization Sector (TSS) H.320 standards for videoconferencing over circuit-switched networks, such as Integrated Services Digital Network (ISDN) or switched 5G. By contrast, the equipment in subnet 12B may communicate using the more recent ITU-TSS H.323 standards for videoconferencing and multimedia communications over packet-switched networks, such as Ethernet, Asynchronous Transfer Mode (ATM), and Frame Relay networks. The networks can include local area networks (LAN's) and wide area networks (WAN's). Furthermore, within each subnet, the devices may have been manufactured by different vendors, and each may utilize a different protocol and/or a different physical communication interface. Some devices may even speak multiple protocols.

One or more network management stations 20A and 20B are used to establish, monitor, and manage video conferences. As explained in the related application, video network manager 24 serves as an intelligent conduit between network management stations 20A and 20B and the video devices in subnets 12A and 12B. For example, video network manager 24 uses one communications protocol to communicate with management stations 20A and 20B, while using a variety of protocols to communicate with the various devices in subnets 12A and 12B via administrative connection 22.

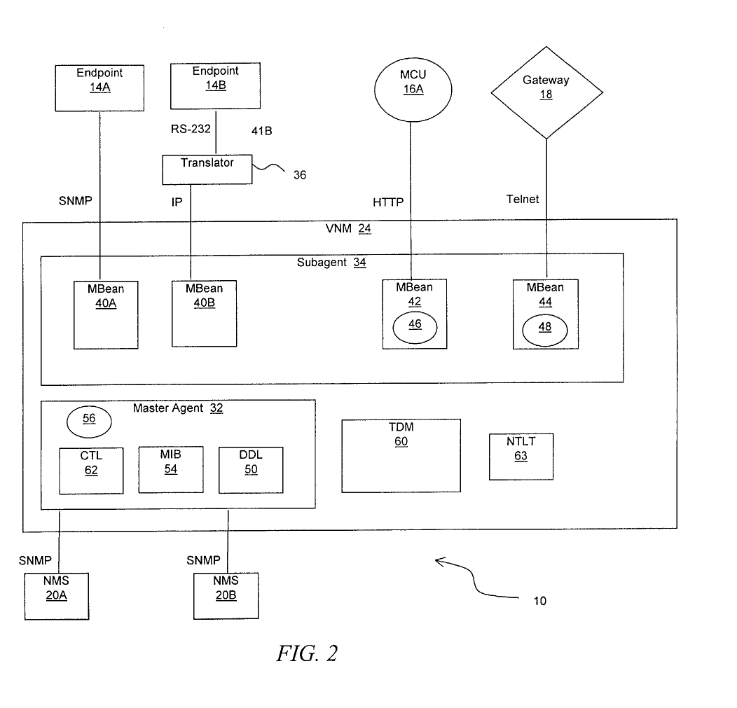

Referring now to FIG. 2, in the example embodiment, video network manager 24 communicates with network management stations 20A and 20B using SNMP. By contrast, video network manager 24 uses a variety of protocols (e.g., SNMP, HTTP, and other IP-based protocols) to communicate with the devices in subnets 12A and 12B. Specifically, in the example embodiment, endpoint 14A supports SNMP, MCU 16A supports HTTP, and gateway 18 supports Telnet. Accordingly, video network manager 24 uses SNMP to communicate with endpoint 14A, HTTP to communicate with MCU 16A, and Telnet to communicate with gateway 18. In addition, endpoint 14B features an RS-232 port, and a buddy box or translator 36 is used to convert data between the RS-232 format and an IP format. Accordingly, network manager 24 uses IP to communicate with endpoint 14B via translator 36. To support the different communications protocols, video network manager 24 uses a subagent 34 that contains management beans 40A, 40B, 42, and 44 for translating communications to and from video network manager 24 between the various device protocols and a uniform internal format.

In addition, video network manager 24 includes a master agent 32, which provides a management information base (MIB) 54 for reference of external devices, such as network management stations 20A and 20B. For instance, MIB 54 provides access to information about a discovered device list (DDL) 50 and a custom trap list (CTL) 62.

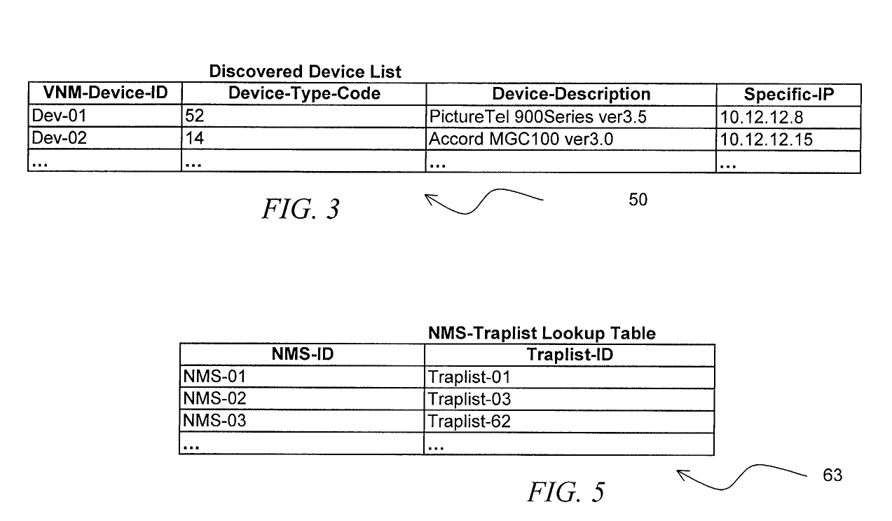

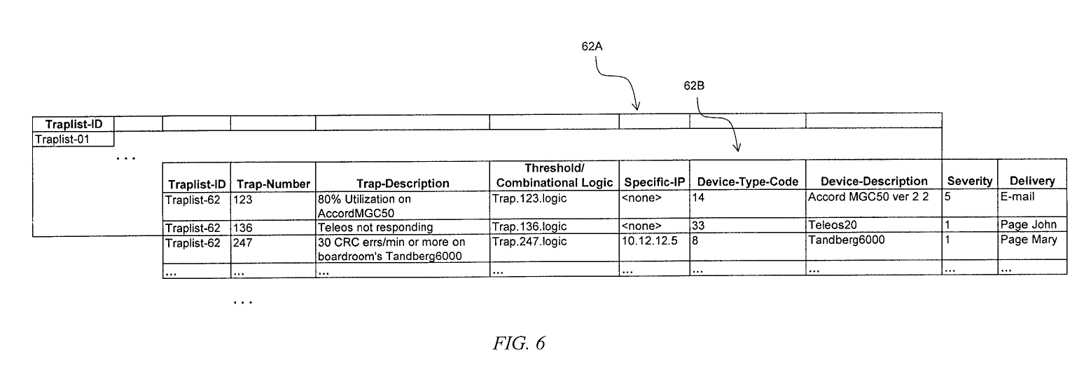

As indicated in FIG. 3, DDL 50 contains information for identifying each video device detected in video network 10. In the example embodiment, for each discovered device, DDL 50 includes fields or columns for a device identifier, a device type code, a device description, and an IP address. The device type code is a numeric value for that specific category of device. The device description is a textual description of the category. As described in greater detail below with reference to FIG. 6, custom trap list 62 contains the custom traps that provide notifications to network management stations 20A and 20B according to user-defined criteria.

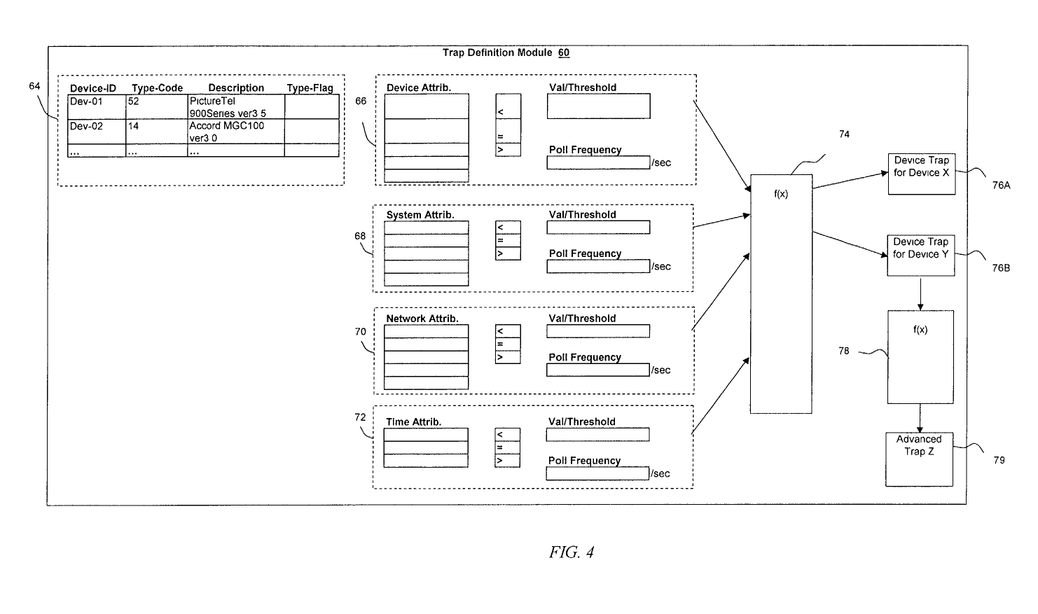

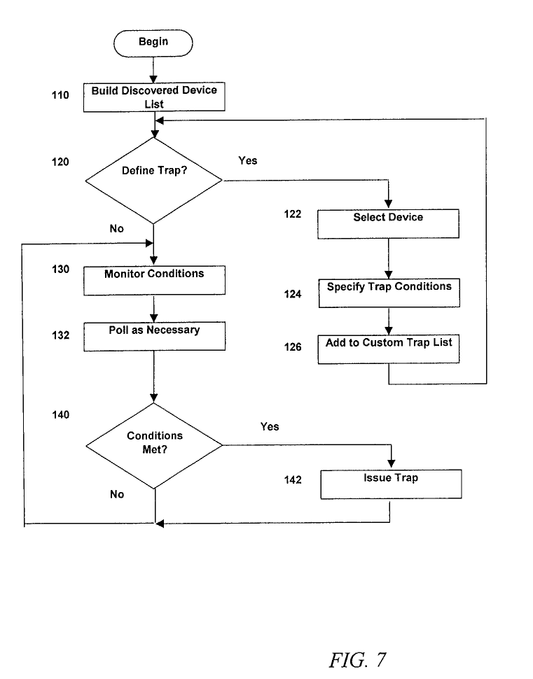

Master agent 32 also includes registration logic 56 for allowing external devices such as network management stations 20A and 20B to register with video network manager 24 (e.g., via Unified Integration Framework (UIF)) for delivery of traps. Video network manager 24 also includes a trap definition module (TDM) 60 and an NMS-traplist lookup table (NTLT) 63. As described below with reference to FIGS. 4 and 7, trap definition module 60 accepts user input defining custom traps. As indicated in FIG. 5, NTLT 63 provides a lookup table of associations between individual network management stations and lists of traps to be provided for the individual network management stations. The administrator for a specific network management station registers with video network manager 24 to receive traps by adding the IP address of that network management station (e.g. NMS-02) as a row to the NTLT 63 and choosing the specific traplist to receive.

Trap definition module 60 includes a variety of components which allow a user such as a network administrator to define custom traps for video network 10. Those components include control logic which provides guidance and mechanisms for receiving user input in a process of defining custom traps. For instance, referring now to FIG. 4, the control logic may present a series of objects in a user interface with instructions and mechanisms for receiving user input for different stages in the process of defining a trap.

With reference also to FIG. 7, an example process for providing custom traps in a video network begins with the network components connected via various communication links, for example as depicted in FIGS. 1 and 2. As indicated at block 110, video network manager 24 then builds discovered device list 50, for example by polling all devices detected in video network 10 or receiving device traps issued by some devices and polling the other devices. As shown at block 120, video network manager 22 then determines whether a user has requested a user interface for defining traps. If the user has requested a trap definition interface, video network manager 24 activates trap definition module 60, which allows the user to select a device using interface components such as device drop down list 64. As indicated at block 122, the user may interact with device dropdown list 64 to select a device to be monitored in the custom trap.

Specifically, in the example embodiment, when device dropdown list 64 is selected, it displays information from DDL 50. In addition, device dropdown list 64 provides a check box on each row under the heading “Type-Flag” to allow the user to specify whether the use is selecting the specific device or the type code. The user checks the check box if the trap is to apply to all devices with the type code in that row (e.g., to all devices with type code 52). The users leaves the check box blank if the trap is only to apply to the specific device (e.g., to the device with the IP address associated with Dev-01 in DDL 50).

As indicated at block 124, video network manager 24 then presents various trap attribute objects that allow the user to specify the conditions which will cause the custom trap to be issued or triggered. Some of the trap attribute objects allow the user to specify different device attributes and thresholds or values to form the basis of trap conditions and trap generation. The trap attribute objects may include dialog boxes of other groups of objects, such as device attribute objects 66, system attribute objects 68, network attribute objects 70, and time attribute objects 72. Device attribute objects 66 allow the user to provide values and or thresholds to be compared with attributes of the device selected through device dropdown list 64. System attribute objects 68 relate to attributes of video network manager 24, such as number of threads, disk space, number of software licenses, etc. Network attribute objects 70 include conditions such as overall network workload or traffic volume, pipeline limits, quality of service (QoS) metrics, etc. For example, network attribute objects 70 may be used to create a trap to indicate that a particular router is underutilized even though overall network traffic exceeds a user-specified value. Time attribute objects 72 include conditions such as time of day, day of week, particular calendar dates, etc. Furthermore, trap definition module 60 provides input objects for the trap attribute of polling frequency, to allow the user to specify how often video network manager 24 is to poll for current conditions pertinent to the trap.

In addition, trap definition module 60 allows the user to customize the data transmitted and the actions taken when issuing traps. For example, as depicted in FIG. 6, different severity levels can specified for transmission with different traps, and additional actions may be specified for automatic execution when traps are issued. For instance, some traps may simply cause trap data to be logged, others may cause video network manager 24 to send e-mail messages to specified users, and other traps may cause video network manager 24 to page or beep specified individuals.

As depicted at block 126, once the user has finished specifying device attributes and thresholds for the custom trap, trap definition module 60 adds the user-defined trap to custom trap list 62. Specifically, as shown in FIG. 4, in the example embodiment, trap definition module 60 includes trap building logic 74, which builds traps and saves traps in custom trap list 62, according to the user specified conditions described above.

Furthermore, trap definition module 60 includes advanced trap building logic 78, which allows users to define traps that consider attributes of multiple devices, combine conditions from previously defined traps, and provide other, more flexible mechanisms for defining traps. For example, trap building logic 74 may be used to define a custom traps 76A and 76B as new traps for devices X and Y, respectively, and advanced trap building logic 78 may be used to build an advanced trap Z (e.g., advanced trap 79), where the triggering conditions for advanced trap 79 are based in part on whether custom trap 76B has been triggered. Thus, custom trap 76A may be triggered when a user-specified attributed of a particular device reaches or exceeds a user-specified threshold, while advanced trap 79 is triggered when custom trap 76A is triggered at the same time as another condition, such as a user-specified day of the week. For instance, a first advanced trap might be based on conditions of two or more devices, second advanced trap might be based on the first advanced trap in combination with whether a video call is scheduled to occur within an hour, and a third advanced trap may include a combination of various custom traps and advanced traps.

In addition, as illustrated in FIG. 6, video network manager 24 groups traps into trap lists, and it is these trap lists that the network management station register to receive. Specifically, custom trap list 62 is a collection of trap tables 62A, 62B, etc., and each trap table contains a group of one or more traps. For example, as indicated by the column headed “Traplist-ID,” trap table 62B contains the traps in Traplist-62. Similarly, trap table 62A contains the traps in Traplist-01. As indicated by the ellipses, numerous additional trap tables may be defined before and after Traplist-62. As shown, each trap table 62B includes a number of columns or fields containing information for a particular user-defined trap. Those fields include a “Threshold/Combinational Logic” field that contains the address of an internal structure which holds the information provided during the trap's configuration. Those fields also include a “Device-Type-Code” field that contains the device type of the selected device and an optional “Specific-IP” field that may contain an IP address for the selected device. In the example embodiment, the list of devices and the corresponding device identifiers in DDL 50 are likely to change over time, for example as the physical configuration of video network 10 changes. The “DeviceType-Code” and “Specific-IP” fields allow the traps to identify devices by device type or IP address, rather than the device identifier.

Once the new trap has been added to custom trap list 62, the process returns to block 120 to allow the user to define additional traps if desired. Once the user has finished defining traps, the process passes from block 120 to block 130, and video network manager 22 begins monitoring network conditions. In addition, if the userdefined traps do not precisely match the device traps provided on the network devices by the device vendors, polling logic in video network manager 24 polls the network devices as necessary to determine whether trap conditions have been met, as indicated at block 132. Video network manager 24 configures the polling logic to minimize the amount of polling performed while providing the status information required to service the custom traps for all registered network management stations. The polling logic may be distributed among the management beans. For example, with reference to FIG. 2, polling logic 46 in management bean 42 may be used to poll HTTP devices and polling logic 48 in management bean 44 may be used to poll Telnet devices.

As shown at block 140, video network manager 24 then determines whether trap conditions have been met and, if so, issues appropriate traps, as indicated at block 142. In the example embodiment, an expert system is used to administer the user-defined rules for trap generation. After a trap has been issued, or after determining that the conditions do not warrant issuing a trap, the process returns to block 130 with video network manager continuing to monitor video network conditions, polling as necessary, and issuing traps as appropriate.

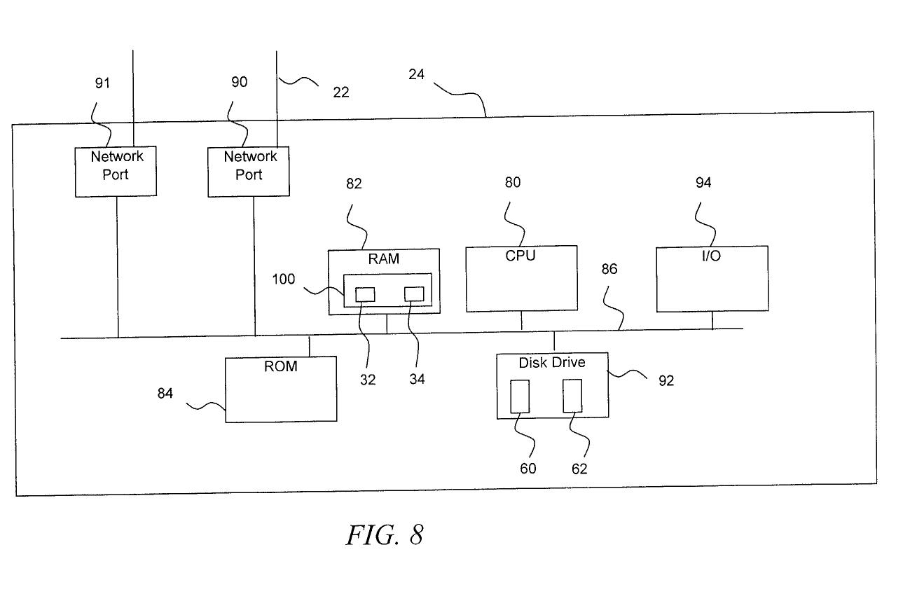

Referring now to FIG. 8, video network manager 24 includes hardware and software for providing custom traps. In the example embodiment, video network manager 24 includes random access memory (RAM) 82, one or more central processing units (CPUs) 80, ROM 84, one or more disk drives 92, and/or other types of nonvolatile memory. Additional components include network ports 90 and 91 for communicating with external devices, such as the equipment in subnets 12A and 12B and network management stations 20A and 20B. Video network manager 24 may also include various input and output (I/O) devices 94, such as a keyboard, a mouse, and a video display. One or more buses 86 carry communications between the various hardware components. The hardware in video network manager 24 may be referred to generally as processing resources.

The software in video network manager 24 includes a management application 100 that includes master agent 32 and subagent 34. Video network manager 24 may store management application 100 locally on nonvolatile memory and may load some or all of management application 100 into RAM 82 in preparation for execution. Network manager 24 may also store trap definition module 60 and NTLT 63 on disk drive 92, to be retrieved into RAM 82 when needed. Alternatively, some or all of the computer instructions and/or data for video network manager 24 may be stored remotely and retrieved as needed, for example from a LAN, a WAN, the Internet, etc.

In the example embodiment, a first network manager stationed at video network manager 24 defines the custom traps, and video network manager 24 issues the traps to network management stations 20A and/or 20B, depending on the defined conditions and depending on which network management stations have registered with video network manager 24. In alternative embodiments, the traps may be defined by users at remote workstations such as network management stations 20A and 20B.

When a network management station receives traps, the network management station may respond differently depending on the severity level of the trap. For example, severity level 12 may simply cause a message to scroll across a window for monitoring conditions in video network 10, while severity level 8 causes text or a cursor to be displayed in a different color. The network management stations may also or alternatively perform the delivery actions specified in the trap definitions, such as paging or sending e-mail to a specified person.

In conclusion, as has been described, the example embodiment provides a system, a method, and a program product for providing custom traps in a video network. Although an example embodiment has been described in detail, the present invention may be implemented in many different ways. In the example embodiment, video network manager 24 is implemented as a client/server application, with the server portion running on a PENTIUM-class personal computer host with a WINDOWS2000 or SOLARIS operating system and one or more Ethernet 10/100 network interfaces. Also, in the example embodiment, network management stations 20A and 20B are PENTIUM-class personal computers executing platform-independent, browser-based implementations of the video network manager client and the network management software. However, in alternative embodiment, data processing systems incorporating the invention may include personal computers, mini computers, mainframe computers, distributed computing systems, and other suitable devices.

Also, the modules and components depicted in the example embodiment represent functional elements that are reasonably self-contained so that each can be designed, constructed, or updated substantially independently of the others. In alternative embodiments, however, it should be understood that the components may be implemented as hardware, software, or combinations of hardware and software for providing the functionality described and illustrated herein.

Additionally, in an alternative embodiments, some of the components of the video network manager could reside on different data processing systems, or some of the components of the network management stations could reside on the same hardware as the video network manager. Alternative embodiments may also utilize different data constructs to store the data pertaining to the network devices and the custom traps without departing from the spirit or scope of the invention.

Furthermore, the present invention may be used to advantage in many types of networks and is not limited to video networks. For example, an alternative embodiment could be used to manage a LAN that include disparate types of devices, devices with disparate levels of support for trap generation, and/or devices configured with different trap-triggering events.

Alternative embodiments of the invention also include computer-usable media encoding logic such as computer instructions for performing the operations of the invention. Such computer-usable media may include, without limitation, storage media such as floppy disks, hard disks, CD-ROMs, read-only memory, and random access memory; as well as communications media such wires, optical fibers, microwaves, radio waves, and other electromagnetic and/or optical carriers.

Many other aspects of the example embodiment may also be changed in alternative embodiments without departing from the scope and spirit of the invention. The scope of the invention is therefore not limited to the particulars of the illustrated embodiments or implementations but is defined by the appended claims.

What is claimed is:

1. A method for issuing custom traps for a network containing disparate network devices, the method comprising:
storing a custom trap in a network manager, wherein the custom trap includes a triggering condition for a selected device among the network devices;
monitoring the selected device to detect whether the triggering condition has been met; and
in response to detecting that the triggering condition has been met, automatically issuing the custom trap.

2. The method of claim 1, wherein the operation of automatically issuing the custom trap comprises automatically issuing the custom trap from the network manager to an administrative workstation.

3. The method of claim 1, wherein:
the operation of storing the custom trap comprises storing the custom trap in a Simple Network Management Protocol (SNMP) agent in the network manager; and
the operation of automatically issuing the custom trap comprises automatically issuing the custom trap from the SNMP agent to an administrative workstation.

4. The method of claim 1, wherein:
the selected device includes a device trap; and
the operation of automatically issuing the custom trap comprises automatically issuing the custom trap from the network manager to an administrative workstation in lieu of forwarding the device trap.

5. The method of claim 1, further comprising:
receiving user input defining the custom trap, wherein the user input specifies an attribute of the selected device and a value for the triggering condition.

6. The method of claim 1, further comprising:
receiving user input defining multiple custom traps, wherein the user input specifies different alert levels for at least two of the multiple custom traps.

7. The method of claim 1, wherein the operation of storing a custom trap comprises storing a triggering condition that is based on attributes of two or more devices among the network devices.

8. The method of claim 1, wherein the selected device comprises a first selected device and the custom trap comprises a first custom trap, the method further comprising:
storing a second custom trap for a second device;
using a first network protocol to monitor the first selected device; and
using a second network protocol to monitor the second selected device.

9. The method of claim 1, further comprising:
accepting registrations from multiple network management stations; and
consulting the registrations to identify a recipient for the custom trap.

10. The method of claim 9, wherein:
the multiple network management stations comprise first and second network management stations;
the method further comprising storing a first set of custom traps in a first trap list and storing a second set of custom traps in a second trap list; and
the operation of accepting registrations from multiple network management stations comprises associating the first network management station with the first trap list and associating the second network management station with the second trap list, such that the custom traps in the first set are issued to the first network management station and the custom traps in the second set are issued to the second network management station.

11. A system for issuing custom traps for a network containing disparate network devices, the system comprising:
a network manager in communication with the network devices;
a trap list in the network manager;
a custom trap in the trap list, wherein the custom trap includes a triggering condition for a selected device among the network devices; and
control logic in the network manager that monitors the selected device to detect whether the triggering condition has been met and automatically issues the custom trap in response to detecting that the triggering condition has been met.

12. The system of claim 11, wherein the network contains an administrative workstation, and wherein:
the network manager further comprises a Simple Network Management Protocol (SNMP) agent;
the network manager stores the custom trap in the SNMP agent; and
the SNMP agent automatically issues the custom trap to the administrative workstation.

13. The system of claim 11, wherein the network manager further comprises:
a trap definition module that receives user input defining the custom trap, wherein the user input specifies an attribute of the selected device and a value for the triggering condition.

14. The system of claim 11, wherein the network manager further comprises:
a trap definition module that receives user input defining multiple custom traps, wherein the user input specifies different alert levels for at least two of the multiple custom traps.

15. The system of claim 11, wherein the custom trap comprises:
a triggering condition that is based on attributes of multiple devices in the network.

16. The system of claim 11, wherein:
the selected device comprises a first selected device;
the custom trap comprises a first custom trap;
the trap list includes a second custom trap for a second device; and
the network manager further comprises:
a first management bean that uses a first network protocol to monitor the first selected device; and
a second management bean that uses a second network protocol to monitor the second selected device.

17. The system of claim 11, wherein the network manager accepts registrations from multiple network management stations and consults the registrations to identify destinations for traps to be issued.

18. A program product for issuing custom traps for a network containing disparate network devices, the program product comprising:
a computer-usable medium; and
computer instructions encoded in the computer-usable medium, wherein the computer instructions, when executed by a data processing system, perform operations comprising:
storing a custom trap in a network manager, wherein the custom trap includes a triggering condition for a selected device among the network devices;
monitoring the selected device to detect whether the triggering condition has been met; and
in response to detecting that the triggering condition has been met, automatically issuing the custom trap.

19. The program product of claim 18, wherein the operation of automatically issuing the custom trap comprises automatically issuing the custom trap from the network manager to an administrative workstation.

20. The program product of claim 18, wherein:
the operation of storing the custom trap comprises storing the custom trap in a Simple Network Management Protocol (SNMP) agent in the network manager; and
the operation of automatically issuing the custom trap comprises automatically issuing the custom trap from the SNMP agent to an administrative workstation.

21. The program product of claim 18, the computer instructions comprise:
a trap definition module that receives user input defining the custom trap, wherein the user input specifies an attribute of the selected device and a value for the triggering condition.

22. The program product of claim 18, wherein the operations performed by the computer instructions further comprise:
receiving user input defining multiple custom traps, wherein the user input specifies different alert levels for at least two of the multiple custom traps.

23. The program product of claim 18, wherein the operation of storing a custom trap comprises storing a triggering condition that is based on attributes of two or more devices among the network devices.

24. The program product of claim 18, wherein the selected device comprises a first selected device, the custom trap comprises a first custom trap, and the operations performed by the computer instructions further comprise:
storing a second custom trap for a second device;
using a first network protocol to monitor the first selected device; and
using a second network protocol to monitor the second selected device.

25. The program product of claim 18, wherein the operations performed by the computer instructions further comprise:
accepting registrations from multiple network management stations; and
consulting the registrations to identify a recipient for the custom trap.
